(19) United States
(12) Patent Application Publication
(10) Pub. No.: US 2013/0187479 A1
(43) Pub. Date: Jul. 25, 2013

(54) ELECTRIC POWER TRANSMISSION SYSTEM AND POWER TRANSMISSION DEVICE USED IN THE ELECTRIC POWER TRANSMISSION SYSTEM

(71) Applicant: MURATA MANUFACTURING CO., LTD., Nagaokakyo-Shi (JP)

(72) Inventors: Takanori Tsuchiya, Nagaokakyo-Shi (JP); Keiichi Ichikawa, Nagaokakyo-Shi (JP)

(73) Assignee: MURATA MANUFACTURING CO., LTD., Nagaokakyo-Shi (JP)

(21) Appl. No.: 13/789,774

(22) Filed: Mar. 8, 2013

Related U.S. Application Data
(63) Continuation of application No. PCT/JP2011/076627, filed on Nov. 18, 2011.

(30) Foreign Application Priority Data
Nov. 25, 2010 (JP) 2010-262839

(51) Int. Cl. H04B 5/00

(52) U.S. Cl. CPC H04B 5/0037; H04B 5/0012
USPC 307/109

(57) ABSTRACT

An electric power transmission system that includes a power receiving device having a first coupling electrode and a power transmission device having a second coupling electrode, both the devices being coupled via an electrostatic field, and the power transmission device configured to transmit electric power to the power receiving device in a noncontact state. The power transmission device includes a third coupling electrode that is disposed at a distance from the second coupling electrode. The third coupling electrode has a potential higher than that of the second passive electrode and lower than that of the second active electrode.

### CROSS REFERENCE TO RELATED APPLICATIONS

The present application is a continuation of International application No. PCT/JP2011/076627, filed Nov. 18, 2011, which claims priority to Japanese Patent Application No. 2010-262839, filed Nov. 25, 2010, the entire contents of each of which are incorporated herein by reference.

### FIELD OF THE INVENTION

The present invention relates to an electric power transmission system that transmits electric power without physical connection, and a power transmission device used in the electric power transmission system.

### BACKGROUND OF THE INVENTION

Recently, a large number of electronic apparatuses that transmit electric power with noncontact have been developed. In order for electronic apparatuses to transmit electric power with noncontact, it is often the case that an electric power transmission system adopting an magnetic field coupling method in which an electric power transmission unit and an electric power receiving unit are both equipped with coil modules is employed.

However, with the magnetic field coupling method, magnitude of a magnetic flux that passes through each coil module is largely influenced by an electromotive force. Therefore, in order to transmit electric power with high efficiency, highly precise control of relative positions in a coil plane direction of a coil module on the power transmission unit (primary side) and a coil module on the power receiving unit (secondary side) is needed. In addition, it is difficult to make the power transmission unit and the power receiving unit be reduced in size because coil modules are used as coupling electrodes. Further, with regard to mobile apparatuses or the like, influence of heat generated in a coil upon a storage battery needs to be taken into consideration in design, which has raised a problem in that influence of the generated heat may become a bottleneck in the design of component distribution.

In response to this, electric power transmission systems using an electrostatic field have been disclosed, for example. An energy transmission system is disclosed in Patent Document 1, in which high efficiency of electric power transmission is obtained by forming a strong electric field between a coupling electrode on a power transmission unit and a coupling electrode on a power receiving unit. In Patent Document 1, a large-sized passive electrode and a small-sized active electrode are provided on the power transmission unit, and a large-sized passive electrode and a small-sized active electrode are also provided on the power receiving unit. High efficiency of electric power transmission is obtained by forming a strong electric field between the active electrode on the power transmission unit and the active electrode on the power receiving unit.

Meanwhile, in Patent Document 2, a transmission system is disclosed in which electric power is transmitted from a coupling electrode of a power transmission unit to a coupling electrode of a power receiving unit via an electrostatic field. In Patent Document 2, because of using an electrostatic field, precise control of relative positions of the coupling electrodes in a plane direction is not required, thereby allowing the degree of freedom in shape and size design of coupling electrodes to be higher.

Patent Document 1: Japanese Unexamined Patent Application Publication (Translation of PCT Application) No. 2009-531009

Patent Document 2: Japanese Unexamined Patent Application Publication No. 2009-296857

Patent Document 3: Japanese Unexamined Patent Application Publication No. 2008-236917

### SUMMARY OF THE INVENTION

However, in electric power transmission systems using an electrostatic field, there has been a risk as follows; that is, when a person makes contact with the system or the like during electric power transmission, problems such as discharging to the human body or the like, malfunction of apparatuses, and so on may arise depending on a charged state of the system. To solve such problems, in Patent Document 3, for example, while monitoring voltage all the time, approach of a foreign object is detected through detecting a change in voltage due to fluctuation in a resonant frequency that is caused by the approach of the foreign object.

As for electric power transmission systems using an electrostatic field, it is an advantage that the degree of freedom is higher in setting a mounting position of a power receiving device; and by making a coupling electrode on a power transmission device relatively larger, a stronger coupling between the coupling electrodes is formed so as to transmit a large amount of electric power. As a result, coupling capacitance therebetween comes to be larger. Accordingly, even in the case where a foreign object such as a human body or the like approaches, a resonant frequency is only slightly influenced. This has been a problem in that a change in voltage cannot be detected based on the fluctuation in the resonant frequency.

In light of the above-mentioned circumstance, an object of the present invention is to provide an electric power transmission system and a power transmission device used in the electric power transmission system, in which even if a foreign object such as a human body approaches during electric power transmission, the approach of a foreign object can be reliably detected, and electric power can be transmitted with high efficiency independently of sizes and relative positions of coupling electrodes. The above-mentioned sizes and relative positions of the coupling electrodes differ depending on shape, size, and the like of a power receiving device in the system.

In order to achieve the aforementioned object, an electric power transmission system according to the present invention includes a power receiving device having a first coupling electrode and a power transmission device having a second coupling electrode, both the devices being coupled via an electrostatic field, and the power transmission device transmits electric power to the power receiving device with noncontact. Further, the power transmission device includes a third coupling electrode that is disposed being distanced from the above-mentioned second coupling electrode.

In the above configuration, since the power transmission device includes the third coupling electrode that is disposed being distanced from the second coupling electrode, electric power transmission to the power receiving device can be carried out using the second coupling electrode, while the detection of approach of a foreign object such as a human body or the like can be carried out using the third coupling electrode. Accordingly, a change in voltage caused by the approach of a foreign object can be reliably detected even during the electric power transmission.

Further, in the electric power transmission system according to the present invention, it is preferable that the first coupling electrode be configured of a first passive electrode and a first active electrode having higher potential than the first passive electrode, the second coupling electrode be configured of a second passive electrode and a second active electrode having higher potential than the second passive electrode, and the third coupling electrode be configured of a third electrode. Furthermore, it is preferable that potential of the third electrode be higher than that of the second passive electrode and lower than that of the second active electrode.

In the above configuration, by making the third electrode have intermediate potential that is higher than the potential of the second passive electrode and lower than the potential of the second active electrode, a smaller change in voltage can be detected at the third electrode, thereby making it possible to surely detect a change in voltage caused by the approach of a foreign object.

Furthermore, in the electric power transmission system according to the present invention, it is preferable that coupling capacitance between the third electrode and the second active electrode be smaller than coupling capacitance between the second active electrode and the second passive electrode.

In the above configuration, because the coupling capacitance between the third electrode and the second active electrode is smaller than the coupling capacitance between the second active electrode and the second passive electrode, a degree of fluctuation in stray capacitance due to the approach of a foreign object at the smaller coupling capacitance side differs from that at the larger coupling capacitance side. This makes it possible to make a change in voltage at the third electrode larger than that at the second active electrode. Accordingly, a change in voltage due to approach of a foreign object can be reliably detected.

In addition, in the electric power transmission system according to the present invention, it is preferable that the second active electrode of the power transmission device and the first active electrode of the power receiving device be opposed to each other, the second passive electrode of the power transmission device and the first passive electrode of the power receiving device be disposed at respective sides opposite to the side where the second active electrode and the first active electrode are opposed to each other, and the third electrode be disposed in a peripheral area of the second active electrode.

In the above configuration, the second active electrode of the power transmission device and the first active electrode of the power receiving device are opposed to each other, while the second passive electrode of the power transmission device and the first passive electrode of the power receiving device are disposed at respective sides opposite to the side where the second active electrode and the first active electrode are opposed to each other. Since the third electrode is disposed in a peripheral area of the second active electrode, a change in voltage due to the approach of a foreign object to the second active electrode of the power transmission device can be reliably detected.

Further, in the electric power transmission system according to the present invention, it is preferable that the power transmission device include a pedestal portion on which the second active electrode is provided and a backrest portion on which the second passive electrode is provided, the second active electrode be disposed in a direction approximately orthogonal to a direction in which the second passive electrode is disposed, and the third electrode be disposed at a side opposite to the second active electrode with the second passive electrode therebetween.

In the above configuration, the power transmission device includes a pedestal portion on which the second active electrode is provided and a backrest portion on which the second passive electrode is provided. The second active electrode is disposed in a direction approximately orthogonal to a direction in which the second passive electrode is disposed, and the third electrode is disposed at a side opposite to the second active electrode with the second passive electrode therebetween, whereby a change in voltage due to the approach of a foreign object to the second active electrode of the power transmission device can be reliably detected. In addition, since the second active electrode and the second passive electrode are arranged approximately orthogonal to each other, stray capacitance can be reduced and the coupling between the second active electrode and the second passive electrode can be strengthened, thereby making it possible to enhance the efficiency of electric power transmission.

In order to achieve the aforementioned object, a power transmission device according to the present invention includes a second coupling electrode and transmits electric power with noncontact to a power receiving device including a first coupling electrode, and both the devices are coupled via an electrostatic field. Further, the power transmission device includes a third coupling electrode that is disposed being distanced from the second coupling electrode.

In the above configuration, since the third coupling electrode that is disposed being distanced from the second coupling electrode is included, electric power transmission to the power receiving device can be carried out using the second coupling electrode, while the detection of approach of a foreign object such as a human body or the like can be carried out using the third coupling electrode. Accordingly, a change in voltage due to the approach of a foreign object can be reliably detected even during the electric power transmission.

Further, in the power transmission device according to the present invention, it is preferable that the first coupling electrode be configured of a first passive electrode and a first active electrode having higher potential than the first passive electrode, the second coupling electrode be configured of a second passive electrode and a second active electrode having higher potential than the second passive electrode, and the third coupling electrode be configured of a third electrode. Furthermore, it is preferable that potential of the third electrode be higher than that of the second passive electrode and lower than that of the second active electrode.

In the above configuration, by making the third electrode have intermediate potential that is higher than the potential of the second passive electrode and lower than the potential of the second active electrode, a smaller change in voltage can be detected at the third electrode, thereby making it possible to surely detect a change in voltage due to approach of a foreign object.

Furthermore, in the power transmission device according to the present invention, it is preferable that coupling capacitance between the third electrode and the second active electrode be smaller than coupling capacitance between the second active electrode and the second passive electrode.

In the above configuration, because the coupling capacitance between the third electrode and the second active electrode is smaller than the coupling capacitance between the second active electrode and the second passive electrode, a degree of fluctuation in stray capacitance due to the approach of a foreign object at the smaller coupling capacitance side differs from that at the larger coupling capacitance side. This makes it possible to make a change in voltage at the third electrode larger than that at the second active electrode. Accordingly, a change in voltage due to the approach of a foreign object can be reliably detected.

In addition, in the power transmission device according to the present invention, it is preferable that the second active electrode and the first active electrode be opposed to each other, the second passive electrode and the first passive electrode be disposed at respective sides opposite to the side where the second active electrode and the first active electrode are opposed to each other, and the third electrode be disposed in a peripheral area of the second active electrode.

In the above configuration, the second active electrode and the first active electrode of the power receiving device are opposed to each other, while the second passive electrode and the first passive electrode of the power receiving device are disposed at respective sides opposite to the side where the second active electrode and the first active electrode are opposed to each other. Since the third electrode is disposed in a peripheral area of the second active electrode, a change in voltage due to approach of a foreign object to the second active electrode can be reliably detected.

Further, the power transmission device according to the present invention may preferably include a pedestal portion on which the second active electrode is provided and a backrest portion on which the second passive electrode is provided; and it is preferable that the second active electrode be disposed in a direction approximately orthogonal to a direction in which the second passive electrode is disposed, and the third electrode be disposed at a side opposite to the second active electrode with the second passive electrode therebetween.

In the above configuration, a pedestal portion on which the second active electrode is provided and a backrest portion on which the second passive electrode is provided are included. The second active electrode is disposed in a direction approximately orthogonal to a direction in which the second passive electrode is disposed, and the third electrode is disposed at a side opposite to the second active electrode with the second passive electrode therebetween, whereby a change in voltage due to the approach of a foreign object to the second active electrode can be reliably detected. In addition, since the second active electrode and the second passive electrode are arranged approximately orthogonal to each other, stray capacitance can be reduced and the coupling between the second active electrode and the second passive electrode can be strengthened, thereby making it possible to enhance the efficiency of electric power transmission.

### ADVANTAGEOUS EFFECTS OF INVENTION

In the electric power transmission system and the power transmission device according to the present invention, since the third coupling electrode that is disposed being distanced from the second coupling electrode is provided, electric power transmission to the power receiving device can be carried out using the second coupling electrode, while the detection of approach of a foreign object such as a human body or the like can be carried out using the third coupling electrode. Accordingly, a change in voltage due to the approach of a foreign object can be reliably detected even during the electric power transmission.

Further, by making the third electrode have intermediate potential that is higher than the potential of the second passive electrode and lower than the potential of the second active electrode, a smaller change in voltage can be detected at the third electrode, thereby making it possible to surely detect a change in voltage due to approach of a foreign object.

Furthermore, because the coupling capacitance between the third electrode and the second active electrode is smaller than the coupling capacitance between the second active electrode and the second passive electrode, a degree of fluctuation in stray capacitance due to the approach of a foreign object at the smaller coupling capacitance side differs from that at the larger coupling capacitance side. This makes it possible to make a change in voltage at the third electrode larger than that at the second active electrode. Accordingly, a change in voltage due to the approach of a foreign object can be reliably detected.

### BRIEF DESCRIPTION OF THE DRAWINGS

FIGS. 1(a) and 1(b) are circuit diagrams schematically illustrating configurations of a power transmission device in an electric power transmission system according to an embodiment of the present invention.

FIG. 2 is an equivalent circuit diagram schematically illustrating a configuration of an electric power transmission system of the past.

FIG. 3 is an equivalent circuit schematically illustrating a configuration of an electric power transmission system according to an embodiment of the present invention.

FIG. 4 is a block diagram illustrating a configuration of a power transmission device in an electric power transmission system according to an embodiment of the present invention.

FIG. 5 is an example of a diagram that illustrates voltage detected by a foreign-object detecting voltmeter of a power transmission device in an electric power transmission system according to an embodiment of the present invention.

FIG. 6 is a schematic diagram illustrating a structure of a power transmission device in an electric power transmission system according to an embodiment of the present invention.

FIG. 7 is a schematic diagram illustrating a state of an electric field on a power transmission device in an electric power transmission system when a foreign object does not approach according to an embodiment of the present invention.

FIG. 8 is a schematic diagram illustrating a state of an electric field on a power transmission device in an electric power transmission system when a foreign object approaches according to an embodiment of the present invention.

FIGS. 9(a) to (c) are schematic diagrams illustrating other structures of a power transmission device in an electric power transmission system according to an embodiment of the present invention.

FIG. 10 is a schematic diagram illustrating a state of an electric field on a power transmission device in an electric power transmission system when a foreign object does not approach according to an embodiment of the present invention.

FIG. 11 is a schematic diagram illustrating a state of an electric field on a power transmission device in an electric power transmission system when a foreign object approaches according to an embodiment of the present invention.

### DETAILED DESCRIPTION OF THE PREFERRED EMBODIMENTS

Hereinafter, an electric power transmission system and a power transmission device that is used in the electric power transmission system according to embodiments of the present invention will be described in detail with reference to the drawings. The embodiments described below are not intended to limit the invention disclosed in the appended claims, and needless to say, not all combinations of the characteristic aspects described in the embodiments are requisite for solution.

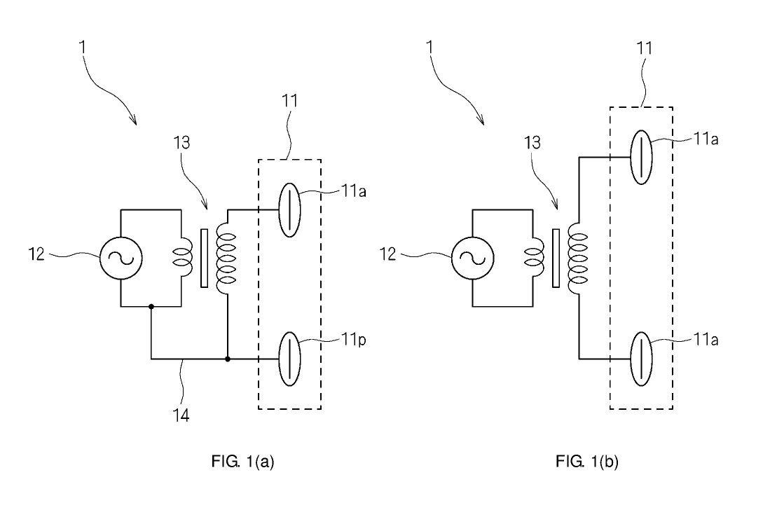

FIG. 1 is a circuit diagram schematically illustrating configurations of a power transmission device in an electric power transmission system according to an embodiment of the present invention. As shown in FIG. 1(a), a power transmission device 1 according to the present embodiment includes at least a high-frequency generator 12, a step-up transformer 13 and a coupling electrode (second coupling electrode) 11. In the circuit shown in FIG. 1(a), when a voltage is stepped up by the step-up transformer 13, an active electrode (second active electrode) 11a becomes to be a higher voltage and a passive electrode (second passive electrode) 11p becomes to be a lower voltage.

Meanwhile, as shown in FIG. 1(b), a grounding wire 14 which is illustrated in FIG. 1(a) is not necessarily needed. In this case, when the step-up transformer 13 performs step-up operation, either electrode in the coupling electrode 11 has a higher voltage, which is equivalent to a state in which a plurality of active electrodes 11a are connected in the circuit. Hereinafter, description will be made based on the configuration of FIG. 1(a); however, it is needless to say that the configuration of FIG. 1(b) will be the same as that of FIG. 1(a) as long as position adjustment of the coupling electrode 11 is concerned. That is to say, two active electrodes 11a are provided in the power transmission device 1 in the configuration of FIG. 1(b), and in response to this, two active electrodes will also be provided in the corresponding power receiving device.

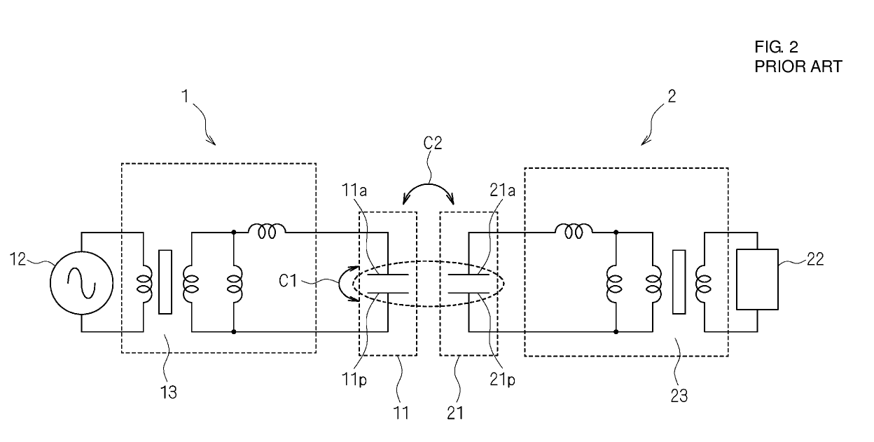

FIG. 2 is an equivalent circuit diagram schematically illustrating a configuration of an electric power transmission system of the past. As shown in FIG. 2, the coupling electrode (second coupling electrode) 11 of the power transmission device 1 is configured of the active electrode (second active electrode) 11a and the passive electrode (second passive electrode) 11p whose size is larger than that of the active electrode 11a, while a coupling electrode (first coupling electrode) 21 of a power receiving device 2 is configured of an active electrode (first active electrode) 21a and a passive electrode (first passive electrode) 21p whose size is larger than that of the active electrode 21a. In other words, the active electrode (second active electrode) 11a and the passive electrode (second passive electrode) 11p are asymmetrically-shaped, and the active electrode (first active electrode) 21a and the passive electrode (first passive electrode) 21p are also asymmetrically-shaped.

In the coupling electrode 11 of the power transmission device 1, capacitance is formed between the active electrode (second active electrode) 11a and the passive electrode (second passive electrode) 11p, while in the coupling electrode 21 of the power receiving device 2, capacitance is also formed between the active electrode (first active electrode) 21a and the passive electrode (first passive electrode) 21p. Accordingly, by disposing the second active electrode 11a and the first active electrode 21a in a strong electric field, the coupling electrodes 11 and 21 are strongly coupled with each other through capacitive coupling so as to transmit electric power. The transmitted electric power is stepped down by a step-down transformer 23 and supplied to a load circuit 22. It is to be noted that although resonant circuits are described in FIG. 2, these resonant circuits are not necessarily needed because they are included therein to enhance the degree of stability of electric power transmission.

Further, electrode capacitance C1 is formed between the second active electrode 11a and the second passive electrode 11p of the power transmission device 1, and coupling capacitance C2 is formed between the second active electrode 11a of the power transmission device 1 and the first active electrode 21a of the power receiving device 2. If a foreign object such as a human body or the like approaches, the electrode capacitance C1 and the coupling capacitance C2 fluctuate. If the electrode capacitance C1 and the coupling capacitance C2 fluctuate, resonant frequency of the resonant circuit also fluctuates. However, fluctuation quantity in stray capacitance due to the approach of a foreign object is relatively smaller compared to the quantity of the electrode capacitance C1 and the coupling capacitance C2, and fluctuation in the resonant frequency is also small. Accordingly, it has been difficult to detect a change in voltage based on fluctuation in resonant frequency.

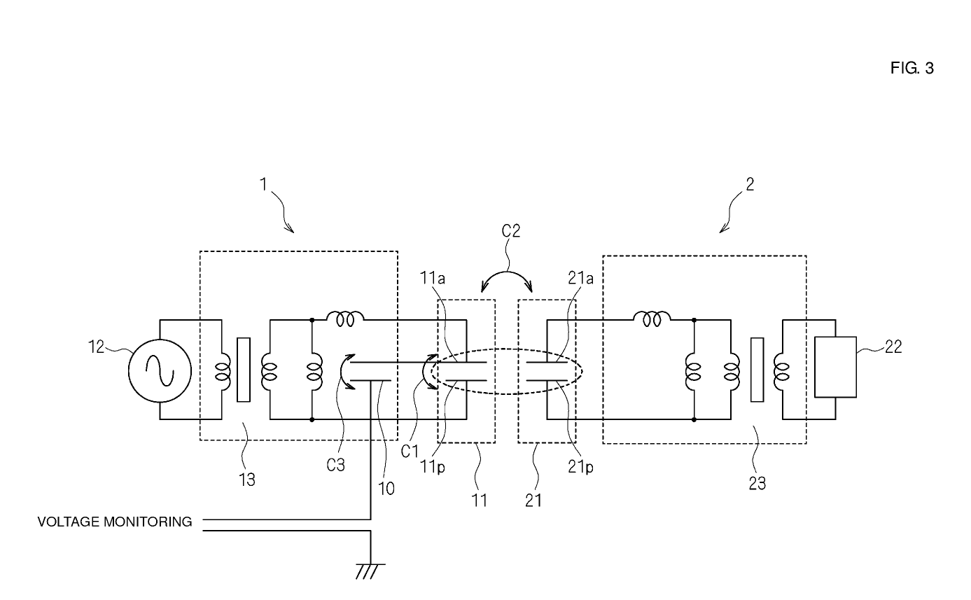

Accordingly, in the present embodiment, a foreign-object detecting electrode (third electrode) is provided at the power transmission device 1 side in addition to the second active electrode 11a. FIG. 3 is an equivalent circuit schematically illustrating a configuration of an electric power transmission system according to an embodiment of the present invention. As shown in FIG. 3, the coupling electrode (second coupling electrode) 11 of the power transmission device 1 is configured of the active electrode (second active electrode) 11a and the passive electrode (second passive electrode) 11p whose size is larger than that of the active electrode 11a, while the coupling electrode (first coupling electrode) 21 of the power receiving device 2 is configured of the active electrode (first active electrode) 21a and the passive electrode (first passive electrode) 21p whose size is larger than that of the active electrode 21a. In other words, the active electrode (second active electrode) 11a and the passive electrode (second passive electrode) 11p are asymmetrically-shaped, and the active electrode (first active electrode) 21a and the passive electrode (first passive electrode) 21p are also asymmetrically-shaped.

The power transmission device 1, different from the past power transmission device, includes a foreign-object detecting electrode (third electrode) 10 as a third coupling electrode that is set at a position distanced from the second active electrode 11a to detect the approach of a foreign object. A foreign-object detecting voltmeter, which will be explained later, is connected between the foreign-object detecting electrode 10 and ground potential to monitor voltage of the foreign-object detecting electrode 10 all the time. Since coupling capacitance C3 between the foreign-object detecting electrode 10 and the second active electrode 11a is smaller than the electrode capacitance C1 between the second active electrode 11a and the second passive electrode 11p, a change in voltage at the foreign-object detecting electrode 10 due to fluctuation in stray capacitance caused by the approach of a foreign object such as a human body or the like becomes relatively larger. Therefore, approach of a foreign object can be detected by detecting a change in voltage at the foreign-object detecting electrode 10.

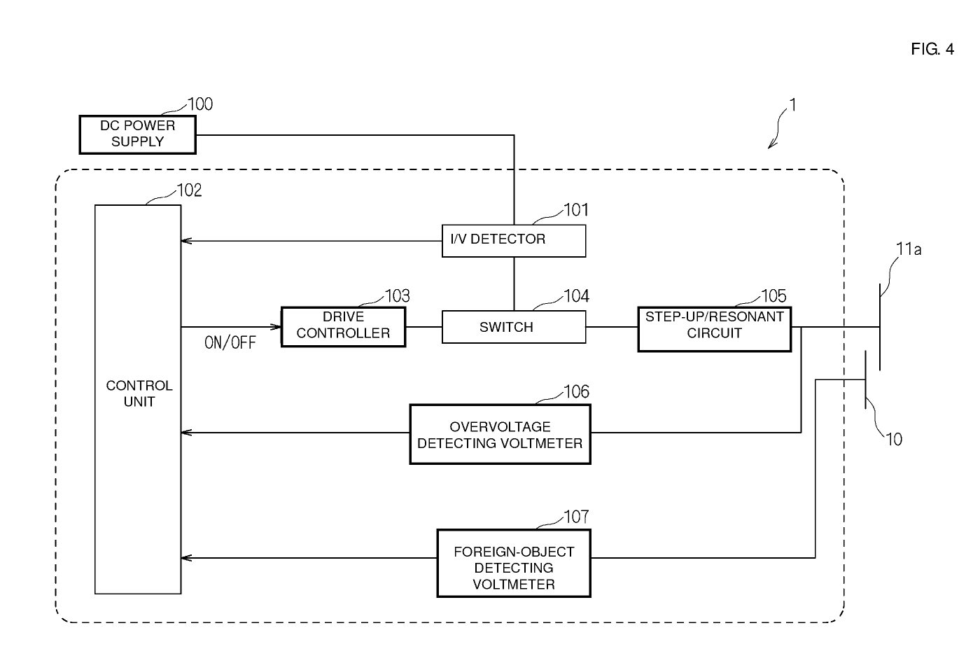

FIG. 4 is a block diagram illustrating a configuration of the power transmission device 1 in an electric power transmission system according to an embodiment of the present invention. A constant-voltage power supply (DC power supply) 100 is a power supply circuit that generates a constant DC voltage (for example, DC 5V). A drive controller 103 and a switch 104 generate a high-frequency voltage of, for example, 100 KHz to tens of MHz using the constant-voltage power supply 100 as a power source. A step-up/resonant circuit 105 steps up high-frequency voltage and supplies it to the second active electrode 11a. An I/V detector 101 detects voltage DCV and current DCI supplied from the constant-voltage power supply 100 and sends the detected data to a control unit 102. The control unit 102, as will be described later, controls operation of the drive controller 103 based on outputs of the I/V detector 101, an overvoltage detecting voltmeter 106 and a foreign-object detecting voltmeter 107.

Potential of the foreign-object detecting electrode 10 is lower than that of the second active electrode 11a of the power transmission device 1 and higher than that of the second passive electrode 11p of the power transmission device 1. Therefore, the potential of the foreign-object detecting electrode 10 has intermediate potential between the potential of the second active electrode 11a of the power transmission device 1 and the potential of the second passive electrode 11p of the power transmission device 1. Here, it is to be noted that in the above description, each potential of the second active electrode 11a of the power transmission device 1, the second passive electrode 11p of the power transmission device 1, and the foreign-object detecting electrode 10 is AC voltage which is applied to each electrode when AC frequency that is generated by the high-frequency generator 12 of the power transmission device 1 is set to operation frequency. The operation frequency is determined as follows in general; that is, the I/V detector 101 detects a frequency at which the highest efficiency of electric power transmission is obtained when the power receiving device 2 is installed, and this detected frequency is set as the operation frequency.

Further, in the case where the coupling capacitance C3 between the foreign-object detecting electrode 10 and the second active electrode 11a is smaller than the electrode capacitance C1 between the second active electrode 11a and the second passive electrode 11p, when a foreign object such as a human body or the like approaches, stray capacitance generated at the coupling capacitance C3 differs from that generated at the electrode capacitance C1. This makes it possible to make a change in voltage at the foreign-object detecting electrode 10 larger than that at the second active electrode 11a. Accordingly, a change in voltage due to approach of a foreign object can be reliably detected.

The overvoltage detecting voltmeter 106 detects output voltage of the step-up/resonant circuit 105 and sends the detected data to the control unit 102. The control unit 102 determines whether or not the output voltage of the step-up/resonant circuit 105 is in a state of overvoltage, that is, exceeds a certain voltage value. If the control unit 102 has determined that the obtained voltage value exceed a certain voltage value, an off-signal is sent therefrom to the drive controller 103.

The foreign-object detecting voltmeter 107 detects a voltage value of the foreign-object detecting electrode 10 and sends the detected data to the control unit 102. The control unit 102 determines that a foreign object has approached, and sends an off-signal to the drive controller 103 in the case where voltage amplitude of the obtained voltage value has been reduced by equal to or more than a predetermined value, for example, and such state has continued for more than a certain period of time.

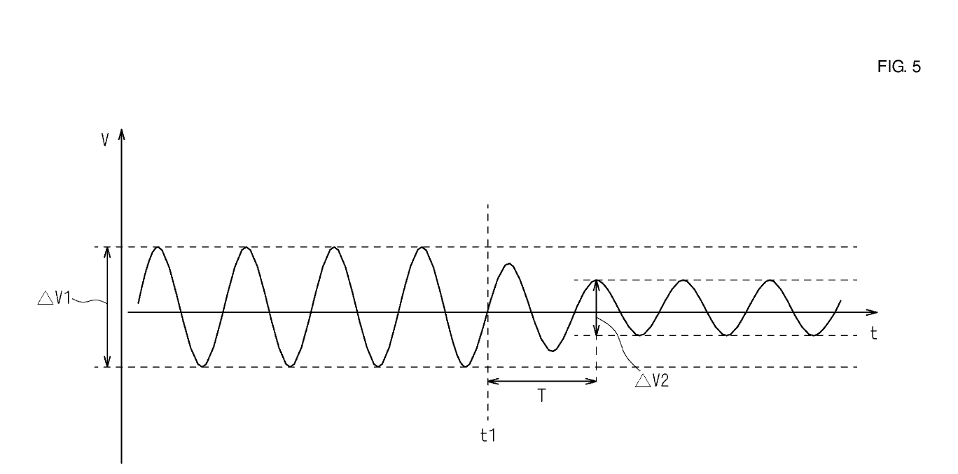

FIG. 5 is an example of a diagram that illustrates voltage detected by the foreign-object detecting voltmeter 107 of the power transmission device 1 in an electric power transmission system according to an embodiment of the present invention. In the case where a foreign object has not approached, voltage amplitude ΔV1 has a constant value, for example, 12 V. In the case where a foreign object has approached at time t=t1, the voltage amplitude is reduced, and after a period of time T has elapsed, voltage amplitude ΔV2 also has a constant value, for example, a reduced value of 8V.

As described above, in the case where voltage amplitude of a voltage value of the foreign-object detecting electrode 10 has been reduced by equal to or more than a predetermined value, for example, equal to or more than 1 volt, and such state has continued for equal to or more than a certain period of time, for example, equal to or more than 1 second, the control unit 102 determines that a foreign object has approached, and sends an off-signal to the drive controller 103 so as to stop the electric power transmission. Accordingly, a risk such that discharging to a human body or the like occurs, and the like can be prevented in advance.

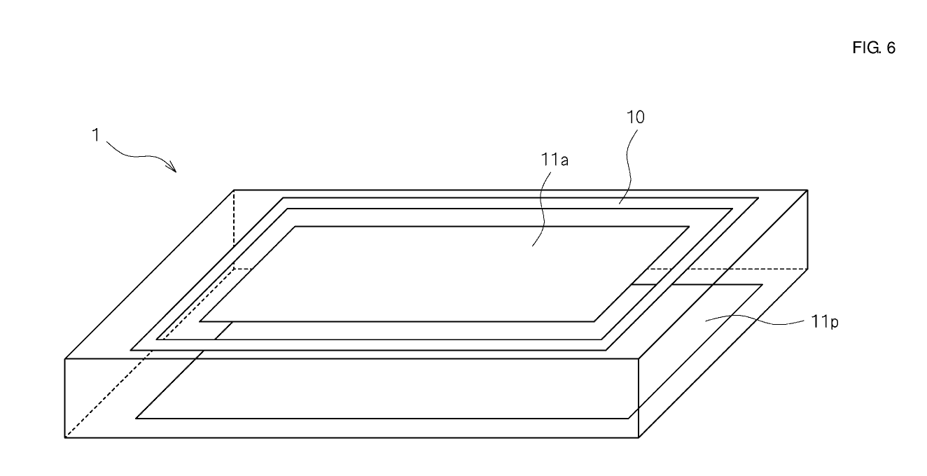

FIG. 6 is a schematic diagram illustrating a structure of the power transmission device 1 in an electric power transmission system according to an embodiment of the present invention. As shown in FIG. 6, the second active electrode 11a is disposed at a side from which electric power is transmitted to the power receiving device 2, and the second passive electrode 11p is disposed at the opposite side. That is, the second active electrode 11a and the second passive electrode 11p are opposed to each other. Although the electrodes described in FIG. 6 are plane-shaped, the shape of electrode is not specifically limited thereto.

The foreign-object detecting electrode (third electrode) 10 is disposed in a peripheral area of the second active electrode 11a, being distanced from the second active electrode 11a. Since the above two electrodes are not in contact with each other, it is possible to make potential of the foreign-object detecting electrode 10 and potential of the second active electrode 11a differ from each other. In the present embodiment, a potential value of the foreign-object detecting electrode 10 is set between those of the second active electrode 11a and the second passive electrode 11p, that is, set to a value of intermediate potential.

As shown in FIG. 6, the foreign-object detecting electrode 10 is formed in a shape surrounding four sides of the second active electrode 11a. However, the shape of the foreign-object detecting electrode 10 is not limited thereto; that is, the foreign-object detecting electrode 10 may be provided in a form of four rectangular-shaped electrodes each of which corresponds to each of the four sides of the second active electrode 11a, or in a form of just one rectangular-shaped electrode that corresponds to any one of the four sides.

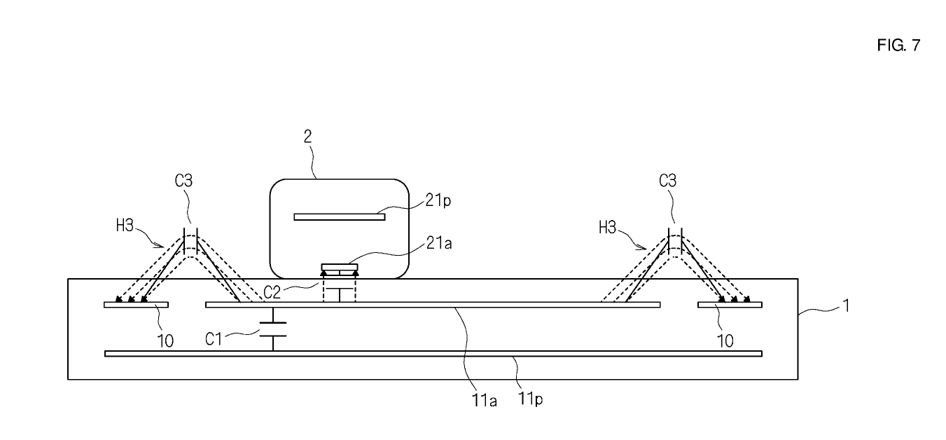

FIG. 7 is a schematic diagram illustrating a state of an electric field when a foreign object does not approach, on the power transmission device 1 in an electric power transmission system according to an embodiment of the present invention. As shown in FIG. 7, the second active electrode 11a of the power transmission device 1 faces the first active electrode 21a of the power receiving device 2; and the second passive electrode 11p of the power transmission device 1 and the first passive electrode 21p of the power receiving device 2 are disposed at respective sides opposite to the side where the second active electrode 11a and the first active electrode 21a are facing each other.

In FIG. 7, the coupling capacitance C3 between the foreign-object detecting electrode 10 and the second active electrode 11a is smaller than the electrode capacitance C1 between the second active electrode 11a and the second passive electrode 11p. When a foreign object does not approach, the coupling capacitance C2 is formed between the second active electrode 11a of the power transmission device 1 and the first active electrode 21a of the power receiving device 2 so as to transmit electric power from the power transmission device 1 to the power receiving device 2. An electric field H3 is generated between the second active electrode 11a and the foreign-object detecting electrode 10, and the coupling capacitance C3 is formed therebetween.

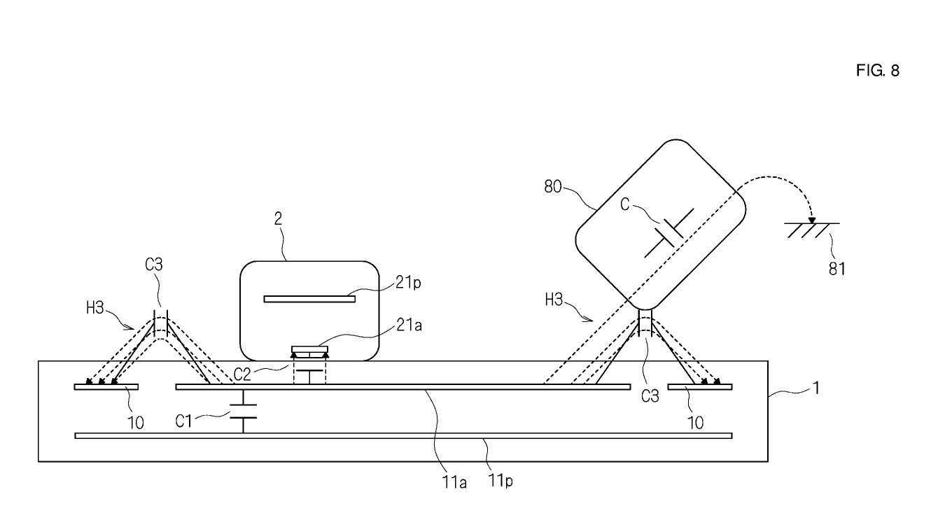

FIG. 8 is a schematic diagram illustrating a state of an electric field when a foreign object approaches, on the power transmission device 1 in an electric power transmission system according to an embodiment of the present invention. In FIG. 8, due to the approach of a foreign object 80 to the foreign-object detecting electrode 10, part of the electric field H3 is induced to ground potential 81 of the foreign object 80, which causes the potential of the foreign-object detecting electrode 10 to be lowered. Accordingly, it is possible to easily detect the approach of the foreign object 80, which is different from the power receiving device 2, by monitoring the voltage of the foreign-object detecting electrode 10 all the time.

In the electric power transmission system according to the present embodiment, the second active electrode 11a of the power transmission device 1 faces the first active electrode 21a of the power receiving device 2, while the second passive electrode 11p of the power transmission device 1 and the first passive electrode 21p of the power receiving device 2 are disposed at respective sides opposite to the side where the second active electrode 11a and the first active electrode 21a are facing each other. However, the configuration of the electric power transmission system is not limited thereto. For example, the power transmission device 1 may be formed of a pedestal portion on which a second active electrode is provided and a backrest portion on which a second passive electrode is provided.

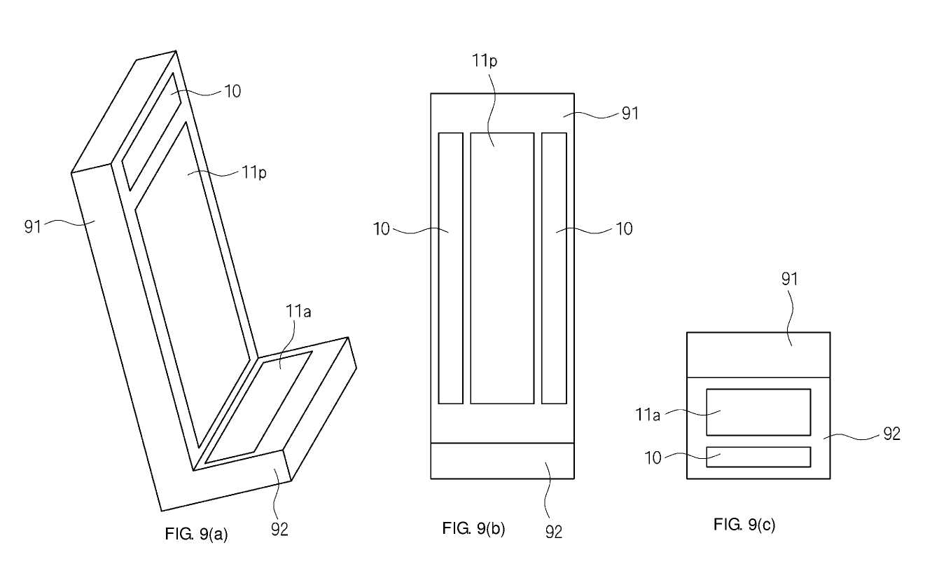

FIG. 9 is a schematic diagram illustrating other structures of the power transmission device 1 in an electric power transmission system according to an embodiment of the present invention. As shown in FIG. 9(a), the second active electrode 11a is provided on a pedestal portion 92 and the second passive electrode 11p is provided on a backrest portion 91. An end of the backrest portion 91 and an end of the pedestal portion 92 are firmly fixed to each other. The backrest portion 91 and the pedestal portion 92 are so arranged as to be approximately orthogonal to each other; in other words, the second active electrode 11a is disposed in a direction approximately orthogonal to a direction in which the second passive electrode 11p is disposed.

The foreign-object detecting electrode 10 is disposed at a side opposite to the second active electrode 11a with the second passive electrode 11p therebetween. With this, the foreign-object detecting electrode 10 can be disposed being distanced from the second active electrode 11a with certainty. It is needless to say that the position of the foreign-object detecting electrode 10 is not limited to any specific position as long as it is distanced from the second active electrode 11a.

For example, as shown in FIG. 9(b), the foreign-object detecting electrode 10 may be disposed on both sides or either one of the two sides of the second passive electrode 11p provided on the backrest portion 91. Further, as shown in FIG. 9(c), the second active electrode 11a and the foreign-object detecting electrode 10 may be disposed on the pedestal portion 92 being distanced from each other.

Similar to FIG. 6, because the foreign-object detecting electrode (third electrode) 10 is disposed being distanced from the second active electrode 11a, it is possible to make the potential values of the foreign-object detecting electrode 10 and the second active electrode 11a differ from each other. Further, the potential value of the foreign-object detecting electrode 10 is between those of the second active electrode 11a and the second passive electrode 11p, that is, a value of intermediate potential.

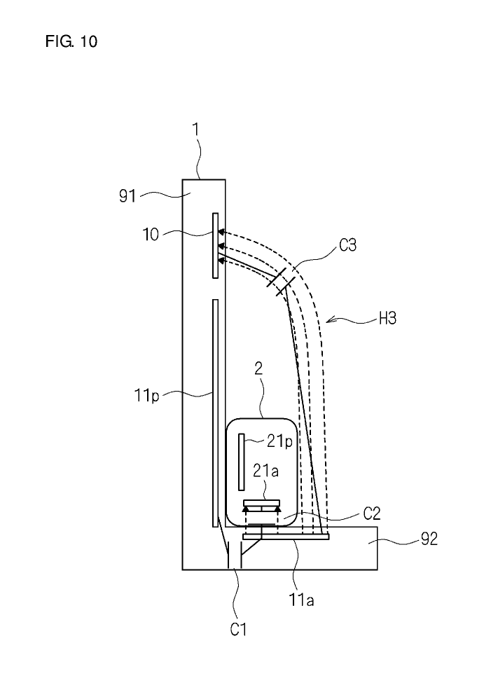

FIG. 10 is a schematic diagram illustrating a state of an electric field when a foreign object does not approach, on the power transmission device 1 in an electric power transmission system according to an embodiment of the present invention. In FIG. 10, the coupling capacitance C3 between the foreign-object detecting electrode 10 and the second active electrode 11a is smaller than the electrode capacitance C1 between the second active electrode 11a and the second passive electrode 11p because the foreign-object detecting electrode 10 and the second active electrode 11a are disposed being distanced from each other. When a foreign object does not approach, the coupling capacitance C2 is formed between the second active electrode 11a of the power transmission device 1 and the first active electrode 21a of the power receiving device 2 so as to transmit electric power from the power transmission device 1 to the power receiving device 2. The electric field H3 is generated between the second active electrode 11a and the foreign-object detecting electrode 10, and the coupling capacitance C3 is formed therebetween.

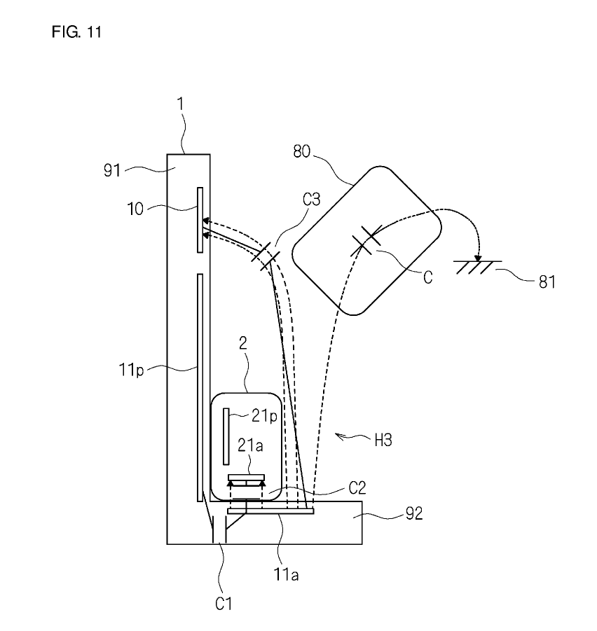

FIG. 11 is a schematic diagram illustrating a state of an electric field when a foreign object approaches, on the power transmission device 1 in an electric power transmission system according to an embodiment of the present invention. In FIG. 11, due to the approach of the foreign object 80 to the foreign-object detecting electrode 10, part of the electric field H3 is induced to the ground potential 81 of the foreign object 80, which causes potential of the foreign-object detecting electrode 10 to be lowered. Accordingly, it is possible to easily detect the approach of the foreign object 80, which is different from the power receiving device 2, by monitoring the voltage of the foreign-object detecting electrode 10 all the time.

According to the present embodiment, as described thus far, because the foreign-object detecting electrode 10 that is disposed being distanced from the second active electrode 11a is provided, electric power transmission to the power receiving device 2 can be carried out using the second active electrode 11a, while the approach of a foreign object such as a human body or the like can be detected using the foreign-object detecting object 10. Accordingly, a change in voltage due to the approach of a foreign object can be detected with certainty even during the electric power transmission.

Furthermore, the present invention is not limited to the examples described above, and needless to say, various kinds of variation, replacement and so on can be made as long as those are within the spirit and scope of the present invention. For example, the active electrode 11a and the passive electrode 11p of the power transmission device 1 are not needed to be asymmetrically-shaped, and may have the same size and same shape. Similarly, the active electrode 21a and the passive electrode 21p of the power receiving device 2 are also not needed to be asymmetrically-shaped, and may have the same size and same shape.

### REFERENCE SIGNS LIST

1 power transmission device

2 power receiving device

10 foreign-object detecting electrode (third electrode)

11 coupling electrode (second coupling electrode)

11a active electrode (second active electrode)

11p passive electrode (second passive electrode)

21 coupling electrode (first coupling electrode)

21a active electrode (first active electrode)

21p passive electrode (first passive electrode)

91 backrest portion

92 pedestal portion

1. An electric power transmission system comprising:
a power receiving device having a first coupling electrode; and
a power transmission device having a second coupling electrode and a third coupling electrode positioned at a distance from the second coupling electrode, the power receiving and power transmission devices being coupled via an electrostatic field,
wherein the power transmission device transmits electric power to the power receiving device in a noncontact state.

2. The electric power transmission system according to claim 1,
wherein the first coupling electrode comprises a first passive electrode and a first active electrode having a higher potential than the first passive electrode,
the second coupling electrode comprises a second passive electrode and a second active electrode having a higher potential than the second passive electrode, and
a potential of the third coupling electrode is higher than that of the second passive electrode and lower than that of the second active electrode.

3. The electric power transmission system according to claim 1,
wherein a first coupling capacitance between the third coupling electrode and the second active electrode is smaller than a second coupling capacitance between the second active electrode and the second passive electrode.

4. The electric power transmission system according to claim 3,
wherein the second active electrode of the power transmission device and the first active electrode of the power receiving device are opposed to each other,
the second passive electrode of the power transmission device is disposed along a side of the power transmission device opposite to a side where the second active electrode and the first active electrode are opposed to each other,
the first passive electrode of the power receiving device is disposed along a side of the power receiving device opposite to the side where the second active electrode and the first active electrode are opposed to each other, and
the third coupling electrode is disposed in a peripheral area of the second active electrode.

5. The electric power transmission system according to claim 2,
wherein the second active electrode of the power transmission device and the first active electrode of the power receiving device are opposed to each other,
the second passive electrode of the power transmission device is disposed along a side of the power transmission device opposite to a side where the second active electrode and the first active electrode are opposed to each other,
the first passive electrode of the power receiving device is disposed along a side of the power receiving device opposite to the side where the second active electrode and the first active electrode are opposed to each other, and
the third coupling electrode is disposed in a peripheral area of the second active electrode.

6. The electric power transmission system according to claim 3,
wherein the power transmission device includes a pedestal portion on which the second active electrode is provided and a backrest portion on which the second passive electrode is provided,
the second active electrode is disposed in a direction approximately orthogonal to a direction in which the second passive electrode is disposed, and
the third coupling electrode is disposed opposite to the second active electrode with the second passive electrode therebetween.

7. The electric power transmission system according to claim 2,
wherein the power transmission device includes a pedestal portion on which the second active electrode is provided and a backrest portion on which the second passive electrode is provided,
the second active electrode is disposed in a direction approximately orthogonal to a direction in which the second passive electrode is disposed, and
the third coupling electrode is disposed opposite to the second active electrode with the second passive electrode therebetween.

8. The electric power transmission system according to claim 1, wherein the third coupling electrode is a foreign-object detecting electrode, and the power transmission device includes a foreign-object detecting voltmeter configured to detect a change in voltage at the foreign-object detecting electrode.

9. The electric power transmission system according to claim 8, further comprising a control unit configured to receive data from the foreign-object detecting voltmeter, and send an off-signal to a drive controller of the power transmission device when the data indicates that the change in voltage at the foreign-object detecting electrode has reached a predetermined value for a predetermined period of time.

10. A power transmission device comprising:
a second coupling electrode configured to transmit electric power in a noncontact state to a power receiving device that includes a first coupling electrode such that the power transmission device and the power receiving device can be coupled via an electrostatic field; and
a third coupling electrode positioned at a distance from the second coupling electrode.

11. The power transmission device according to claim 10,
wherein the first coupling electrode comprises a first passive electrode and a first active electrode having a higher potential than the first passive electrode,
the second coupling electrode comprises a second passive electrode and a second active electrode having a higher potential than the second passive electrode, and
a potential of the third coupling electrode is higher than that of the second passive electrode and lower than that of the second active electrode.

12. The power transmission device according to claim 10,
wherein a first coupling capacitance between the third coupling electrode and the second active electrode is smaller than a second coupling capacitance between the second active electrode and the second passive electrode.

13. The power transmission device according to claim 12,
wherein the second active electrode and the first active electrode are opposed to each other,
the second passive electrode is disposed along a side of the power transmission device opposite to the side where the second active electrode and the first active electrode are opposed to each other, and
the third electrode is disposed in a peripheral area of the second active electrode.

14. The power transmission device according to claim 11,
wherein the second active electrode and the first active electrode are opposed to each other,
the second passive electrode is disposed along a side of the power transmission device opposite to the side where the second active electrode and the first active electrode are opposed to each other, and
the third electrode is disposed in a peripheral area of the second active electrode.

15. The power transmission device according to claim 12, further comprising:
a pedestal portion on which the second active electrode is provided; and
a backrest portion on which the second passive electrode is provided,
wherein the second active electrode is disposed in a direction approximately orthogonal to a direction in which the second passive electrode is disposed, and
the third coupling electrode is disposed opposite to the second active electrode with the second passive electrode therebetween.

16. The power transmission device according to claim 11, further comprising:
a pedestal portion on which the second active electrode is provided; and
a backrest portion on which the second passive electrode is provided,
wherein the second active electrode is disposed in a direction approximately orthogonal to a direction in which the second passive electrode is disposed, and
the third coupling electrode is disposed opposite to the second active electrode with the second passive electrode therebetween.

17. The power transmission device according to claim 10, wherein the third coupling electrode is a foreign-object detecting electrode, and the power transmission device includes a foreign-object detecting voltmeter configured to detect a change in voltage at the foreign-object detecting electrode.

18. The power transmission device according to claim 17, further comprising a control unit configured to receive data from the foreign-object detecting voltmeter, and send an off-signal to a drive controller of the power transmission device when the data indicates that the change in voltage at the foreign-object detecting electrode has reached a predetermined value for a predetermined period of time.
